(19) United States
(12) Patent Application Publication
(10) Pub. No.: US 2012/0281845 A1
(43) Pub. Date: Nov. 8, 2012

(54) METHOD FOR DETERMINING AN IMPEDANCE OF AN ELECTROACOUSTIC TRANSDUCER AND FOR OPERATING AN AUDIO PLAYBACK DEVICE

(75) Inventor: Georg Siotis, Lund (SE)

(73) Assignee: SONY ERICSSON MOBILE COMMUNICATIONS AB, Lund (SE)

(21) Appl. No.: 13/513,186

(22) PCT Filed: May 5, 2011
(86) PCT No.: PCT/EP2011/002249

§ 371 Date: May 31, 2012

(51) Int. Cl. H04R 29/00

(52) U.S. Cl. 381/56

(57) ABSTRACT

A method for determining an impedance of an electroacoustic transducer (13) is provided. The electroacoustic transducer (13) is to be arranged in an ear channel of an ear (19) of a user. According to the method, an output signal is supplied to the electroacoustic transducer (13) and an input signal indicating an impedance of the electroacoustic transducer (13) in response to the supplied output signal is determined. A filtered output signal is generated by filtering the output signal with a bandpass filter having a predetermined frequency range. A filtered input signal is generated by filtering the input signal with a bandpass filter having the predetermined frequency range. Based on the filtered output signal and the filtered input signal the impedance (21, 22) of the electroacoustic transducer (13) is determined for the predetermined frequency range.

### FIELD OF THE INVENTION

The present application relates to a method for determining an impedance of an electroacoustic transducer to be arranged in an ear channel of an ear of a user, a method for determining an impedance characteristic of an electroacoustic transducer, a method for operating an audio playback device, and to a playback device.

### BACKGROUND OF THE INVENTION

In-ear loudspeakers are commonly used to reproduce speech or music of a mobile device to a user. In-ear loudspeakers are also called in-ear headsets, in-ear headphones or in-ear monitors. An in-ear loudspeaker may comprise an electroacoustic transducer adapted to convert an electrical signal into an acoustical signal. The electroacoustic transducer may comprise for example an electrodynamic transducer. For reproducing sound, for example music or speech from the mobile device, the electroacoustic transducer may be arranged in an ear channel of an ear of a user. However, due to different ear channels of different users, different users will experience different frequency responses from the in-ear loudspeaker. Different volumes of different ear channels and different geometric shapes of different ear channels may cause the different frequency responses. Even differences between a left ear channel and a right ear channel of one user may result in different frequency responses of in-ear loudspeakers in the left ear and the right ear. A lot of work has been done during design of in-ear loudspeakers to choose a general frequency respond that fits to all users. However, one equalization curve that fits one user will be inadequate for another user.

Therefore, there is a need for optimizing a frequency response of an in-ear loudspeaker for different ear channels of different users.

### SUMMARY OF THE INVENTION

According to the present invention, this object is achieved by a method for determining an impedance of an electroacoustic transducer as defined in claim 1, a method for determining an impedance characteristic of an electroacoustic transducer as defined in claim 12, a method for operating an audio playback device as defined in claim 13, and an audio playback device as defined in claim 23. The dependent claims define preferred and advantageous embodiments of the invention.

According to an aspect of the present invention, a method for determining an impedance of an electroacoustic transducer is provided. The electroacoustic transducer is to be arranged in an ear channel of an ear of a user. According to the method, an output signal, for example a wanted output signal like a speech audio signal or a music audio signal, is supplied to the electroacoustic transducer. The output signal may be arbitrarily selectable by the user. Therefore, the output signal may comprise for example music to which the user is listening or speech of a telephone call. In response to the supplied output signal an input signal indicating an impedance of the electroacoustic transducer is determined. For example, a resistor may be coupled in series to the electroacoustic transducer, and a voltage over the resistor may be determined and based on this determined voltage the input signal may be determined. Furthermore, a filtered output signal is generated by filtering the output signal. The filtered output signal mainly comprises only frequency components having a frequency within a predetermined frequency range. The filtered output signal may be generated with a bandpass filter which suppresses mainly the frequency components outside of the predetermined frequency range and which passes the frequency component within the predetermined frequency range. Further, a filtered input signal is generated by filtering the input signal, wherein the filtered input signal mainly comprises only frequency components having a frequency within the predetermined frequency range. Again, the filtered input signal may be generated from the input signal using a bandpass filter. Based on the filtered output signal and the filtered input signal the impedance of the electroacoustic transducer is determined at the predetermined frequency range. The impedance of the electroacoustic transducer may be determined while the electroacoustic transducer is arranged in the ear channel of the user. The electroacoustic transducer may comprise an electroacoustic transducer of a portable hands free set of a mobile device, for example a so called ear phone or ear speaker which may be inserted into the ear channel of the user. Furthermore, the electroacoustic transducer may comprise a so called in-ear monitor (IEM).

By filtering the input signal and the output signal and determining the impedance of the electroacoustic transducer based on the filtered input and output signals, the impedance of the electroacoustic transducer may be determined while arbitrary music or speech data is reproduced via the electroacoustic transducer. Therefore, the user of the electroacoustic transducer will not recognize that the impedance of the electroacoustic transducer is determined. Furthermore, as the input signal is generated while the electroacoustic transducer is arranged in the ear channel of the user, the impedance of the electroacoustic transducer arranged in the ear channel of the user can be determined. As the arrangement of the electroacoustic transducer in the ear channel influences the impedance of the electroacoustic transducer, the impedance of the combination of the electroacoustic transducer and the ear channel can be determined with a high accuracy.

According to an embodiment, the output signal comprises an audio signal comprising frequency components inside and outside the predetermined frequency range. Therefore, the audio signal may comprise any kind of speech or music audio signals. By filtering the input signal and the output signal, the impedance of the electroacoustic transducer can be determined for a specific frequency range based on the audio signal without using a test signal which the user may not want to hear.

The predetermined frequency range may comprise for example one or more octaves, or for example a range from 400 Hz to 500 Hz, a range from 500 Hz to 625 Hz, a range from 625 Hz to 800 Hz, a range from 800 Hz to 1000 Hz, or a range from 1000 Hz to 1250 Hz, a range from 1250 Hz to 1600 Hz, a range from 1600 Hz to 2000 Hz, a range from 2000 Hz to 2500 Hz, a range from 2500 Hz to 3200 Hz, a range from 3200 Hz to 4000 Hz, and a range from 4000 Hz to 4800 Hz. By determining the impedance of the electroacoustic transducer arranged in the ear channel of the user in steps of an octave or the above-defined frequency ranges, a pretty good impedance characteristic of the electroacoustic transducer arranged in the ear channel can be provided. However, as only a few ranges have to be analyzed, an impedance characteristic of the most important frequency ranges of the combination of the electroacoustic transducer and the ear channel can be determined in a short time.

According to a further embodiment, the impedance of the electroacoustic transducer is determined at the predetermined frequency range by determining a quotient of the filtered output signal and the filtered input signal. Thus, the impedance of the electroacoustic transducer can be calculated in an easy way. The impedance may comprise a magnitude component and a phase component. Based on the magnitude component and the phase component a resonance frequency and its quality value for a given combination of an electroacoustic transducer and an ear channel may be calculated, for example by extracting the information from real and imaginary parts of the impedances.

According to another aspect of the present invention, a method for determining an impedance characteristic of an electroacoustic transducer to be arranged in-ear channel of a user is provided. The method comprises the following steps. First, a plurality of impedances at a plurality of different frequency ranges is determined by subsequently performing the method steps for determining an impedance of an electroacoustic transducer as described above. Based on the plurality of different predetermined frequency ranges and the correspondingly determined plurality of impedances, the impedance characteristic is determined. The frequency ranges may be selected as described above or any other frequency ranges may be used for determining the impedance characteristic as desired. For example, if a more detailed impedance characteristic is desired, smaller frequency ranges may be selected. Thus, an impedance characteristic of the combination of the electroacoustic transducer and the ear channel in which the electroacoustic transducer is arranged can be determined without supplying a test signal to the electroacoustic transducer. Rather, the impedance characteristic can be determined “on the fly” when the user is listening to music or speech data.

According to the present invention furthermore a method for operating an audio playback device is provided. The audio playback device comprises an electroacoustic transducer to be arranged in an ear channel of an ear of a user of the playback device. According to the method, a resonance frequency of the electroacoustic transducer is determined and based on the determined resonance frequency an audio output signal which is output from the audio playback device via the electroacoustic transducer is adapted. For example, the resonance frequency of the electroacoustic transducer may be determined by determining an impedance characteristic of the electroacoustic transducer as described above, searching for a maximum of a magnitude component of the impedance in the impedance characteristic, and determining the resonance frequency based on a corresponding frequency of the maximum of the magnitude component. Furthermore, the resonance frequency may be determined by searching for a sign change of a phase component of the impedance in the impedance characteristic and determining the resonance frequency based on a frequency at the sign change of the phase component. Furthermore, based on the impedance characteristic a quality value may be determined. For adapting the audio output signal, the audio output signal may be filtered by attenuating the audio output signal in a predetermined frequency range around the resonance frequency. Furthermore, filtering characteristics for filtering the audio output signal may be based on the quality value. Thus, the audio output signal may be adapted or equalized to the present combination of the electroacoustic transducer and the ear channel in which the electroacoustic transducer is mounted. The step of determining the resonance frequency may be performed repeatedly in predetermined time intervals. Thus, by using this regular calibration scheme, an optimized audio output can be continuously provided.

Furthermore, the resonance frequency may be determined in response to a user command. For example, when the user first uses the electroacoustic transducer or when the electroacoustic transducer is given to another user, the resonance frequency can immediately be determined in response to the user command and thus the audio output signal may be immediately adapted and optimized.

According to another embodiment, an impedance characteristic of the electroacoustic transducer arranged in the ear channel of the user is determined as described above, and based on the determined impedance characteristic it is determined if the electroacoustic transducer is mounted correctly in the ear of the user. For example, the quality value may additionally be considered for detecting if the electroacoustic transducer is correctly mounted. Especially, when the electroacoustic transducer is not mounted correctly in the ear channel and a so called “leaking” occurs due to an incorrect arrangement of the electroacoustic transducer in the ear channel, this may be determined based on the quality value. A corresponding message may be output to the user.

According to another embodiment, an impedance characteristic of the electroacoustic transducer is determined as described above and based on the determined impedance characteristic it is determined if a change in the ear channel has occurred. For example, an abnormal change in the ear channel resonance frequency may be detected, when the resonance frequency abruptly changes which may indicate a lower ear channel volume. This may occur for example due to a shrinking of the tissue around the ear channel which may indicate an ear related issue, for example an ear channel inflammation. This may be output as a warning to the user.

According to the present invention, furthermore an audio playback device is provided. The audio playback device comprises an electroacoustic transducer to be arranged in an ear channel of an ear of a user of the audio playback device, and a control unit coupled to the electroacoustic transducer. The control unit is adapted to supply an output signal to the electroacoustic transducer and to determine an input signal indicating an impedance of the electroacoustic transducer in response to the applied output signal. By filtering the output signal a filtered output signal is generated. The filtered output signal mainly comprises only frequency components having a frequency within a predetermined frequency range. In this context the term “mainly comprises” means that the filtered output signal may be generated by filtering the output signal with a bandpass filter having the predetermined frequency range. Although an ideal bandpass filter should completely attenuate frequencies outside the predetermined frequency range and pass frequencies within the predetermined frequency range, such ideal bandpass filters are difficult to realize and therefore for the present invention a bandpass filter is sufficient which suppresses mainly the frequency components outside the predetermined frequency range and passes mainly the frequency components within the predetermined frequency range. Furthermore, by filtering the input signal, a filtered input signal is generated and the filtered input signal mainly comprises only frequency components having a frequency within the predetermined frequency range. Based on the filtered input signal and the filtered output signal the impedance of the electroacoustic transducer at the predetermined frequency range is determined.

The audio playback device may be adapted to perform the above-described methods and comprises therefore the above-described advantages.

The audio playback device may comprise for example a mobile phone, a mobile personal digital assistant, a mobile music player, a personal computer, a HiFi unit or a navigation system.

The audio playback device may furthermore be adapted to determine the impedance of the electroacoustic transducer while the electroacoustic transducer is arranged in the ear channel of the user.

Although specific features described in the above summary and the following detailed description are described in connection with specific embodiments, it is to be understood that the features of the embodiments can be combined with each other unless specifically noted otherwise.

### BRIEF DESCRIPTION OF THE DRAWINGS

The invention will now be described in more detail with reference to the accompanying drawings.

FIG. 1 shows an audio playback device according to an embodiment of the present invention.

FIG. 2 shows an impedance characteristic of an electroacoustic transducer arranged in an ear channel of a user determined according to an embodiment of the present invention.

FIG. 3 shows a filtering characteristic for adapting an output signal according to an embodiment of the present invention.

### DETAILED DESCRIPTION OF PREFERRED EMBODIMENTS

In the following, exemplary embodiments of the present invention will be described in more detail. It has to be understood that the following description is given only for the purpose of illustrating the principals of the invention and is not to be taken in a limiting sense. Rather, the scope of the invention is defined only by the appended claims and not intended to be delimited by the exemplary embodiments herein after.

It is to be understood that the features of the various exemplary embodiments described herein may be combined with each other unless specifically noted otherwise.

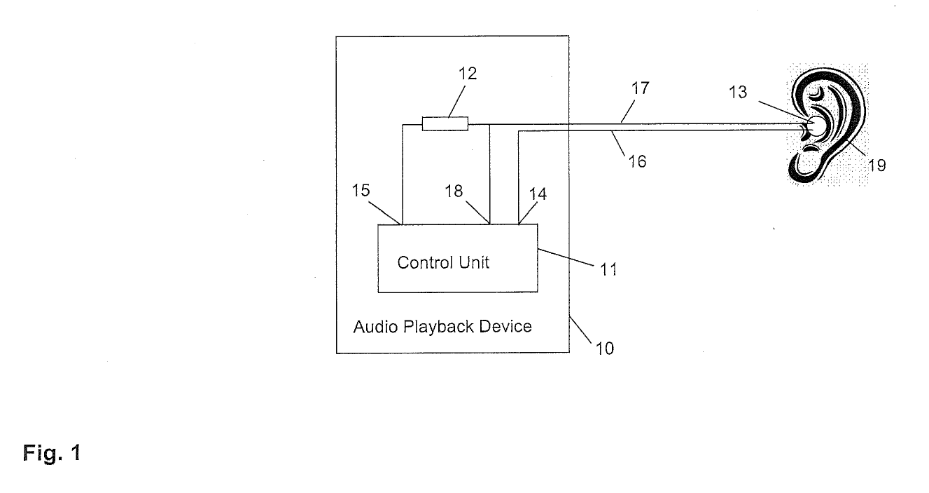

FIG. 1 schematically shows an audio playback device 10, for example a mobile phone. The audio playback device 10 comprises a control unit 11, a resistor 12, and an electroacoustic transducer 13. The audio playback device 10 may comprise a lot more components (not shown), for example a memory unit for storing audio files or music files, an input device and an output device for forming a user interface, a radio frequency unit for receiving radio signals like radio broadcast signals or signals of a mobile communication network, and a battery for powering the audio playback device 10. However, these components are not shown for reasons of clarity. The electroacoustic transducer 13 may comprise for example a loudspeaker of a portable hands free set, a so called in-ear monitor. The control unit 11 may comprise a first output terminal 14 and a second output terminal 15 for outputting audio data to the electroacoustic transducer 13. The first audio output 14 is directly coupled via a connection 16 to the electroacoustic transducer 13. The second output 15 is coupled via the series resistor 12 and the connection 17 to the electroacoustic transducer 13. A terminal of the resistor 12 which is coupled to the electroacoustic transducer 13 is additionally coupled to an input terminal 18 of the control unit 11. When outputting an audio signal to the electroacoustic transducer 13 via the output terminals 14 and 15, the control unit 11 can monitor a voltage via the resistor 12 at terminals 15 and 18. Based on the audio output signal of the control unit 11 delivered at terminals 14 and 15 and based on the voltage over the resistor 12, an impedance of the electroacoustic transducer 13 can be determined. However, the impedance of the electroacoustic transducer 13 depends on an environment in which the electroacoustic transducer is used, especially when the electroacoustic transducer 13 is mounted in an ear channel of an ear 19 of a user of the audio playback device 10.

In operation of the audio playback device 10, during a normal playback of for example music or speech data a software program of the control unit 11 places a bandpass filter that corresponds a wandering sweep frequency from for example a few hundred Hz to several kHz on both the outgoing signal at terminals 14 and 15, and the incoming signal over the resistor 12 at terminals 15 and 18. However, the unfiltered audio output signal is output to the electroacoustic transducer 13, and the filtered audio output signal is used in the control unit 11 for determining the impedance. The filtered audio output signal represents a small frequency range of the currently audio output signal. By calculating a quotient between the two filtered signals a value proportional to the impedance of the electroacoustic transducer in combination with the ear channel can be determined for the filtered frequencies. The wandering sweeping frequency for the filter may comprise for example a sequence of the following frequency ranges: A first frequency range from 400 Hz to 500 Hz, a second frequency range from 500 Hz to 625 Hz, a third frequency range from 625 Hz to 800 Hz, a fourth frequency range from 800 Hz to 1000 Hz, a sixth frequency range from 1000 Hz to 1250 Hz, a seventh frequency range from 1250 Hz to 1600 Hz, an eighth frequency range from 1600 Hz to 2000 Hz, a ninth frequency range from 2000 Hz to 2500 Hz, a tenth frequency range from 2500 Hz to 3200 Hz, an eleventh frequency range from 3200 Hz to 4000 Hz, and a twelfth frequency range from 4000 Hz to 4800 Hz. However, any other sequence of frequency ranges may be used for determining different impedances of the electroacoustic transducer at different frequency ranges.

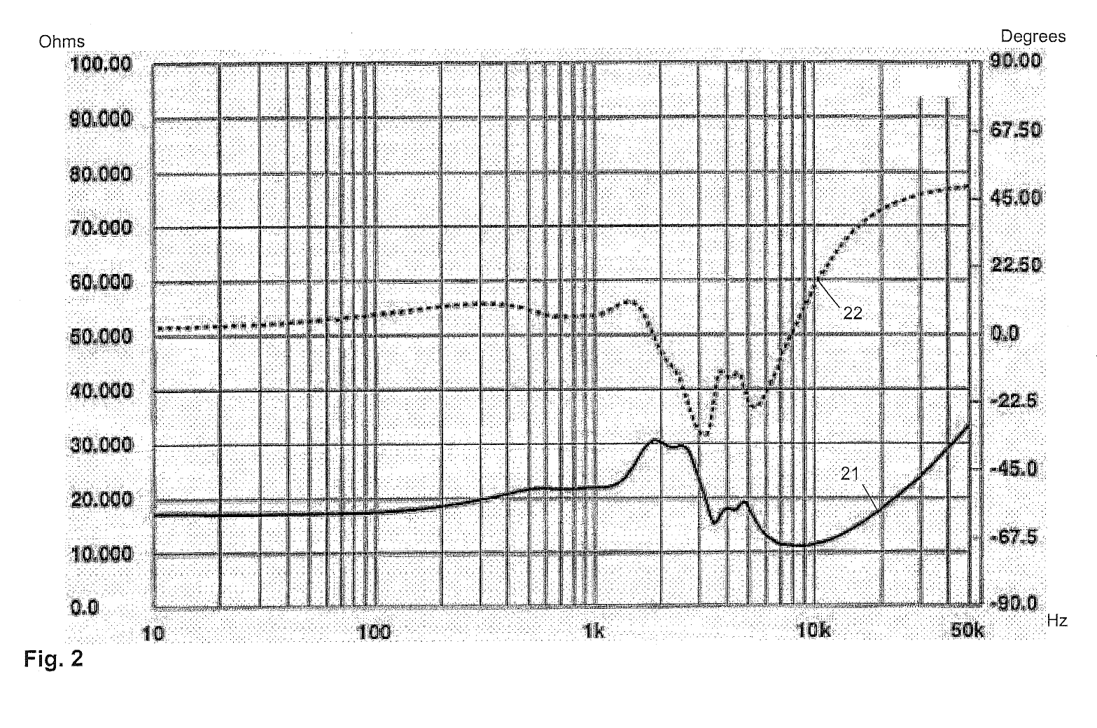

FIG. 2 shows an impedance characteristic of an electroacoustic transducer based on a plurality of impedances determined at a plurality of frequency ranges. The solid curve 21 shows a magnitude value of the impedance and the dotted curve 22 shows a phase component of the impedance. An acoustic system will have a higher impedance at its resonance frequency. The amount of this impedance increase will depend on the quality value (Q-value) of the audio system. The resonance frequency may be found at a maximum of the magnitude of the impedance characteristic. Furthermore, the resonance frequency may be found at a sign change of the phase component of the impedance characteristic. In the example shown in FIG. 2 a maximum of the impedance component (solid curve 21) is around 1800 Hz. Furthermore, as can be seen from FIG. 2, a sign change of the phase component (dotted curve 22) occurs around 1800 Hz indicating the resonance frequency of the combination of the electroacoustic transducer and the ear channel.

Thus, an impedance characteristic and a resonance frequency of the combination of the electroacoustic transducer and the ear channel in which the electric transducer is arranged, can be determined without the user noticing anything else than the audio data which the user wants to hear, as no additional test signal has to be provided to the electroacoustic transducer 13 and no modification of the wanted audio signal is performed.

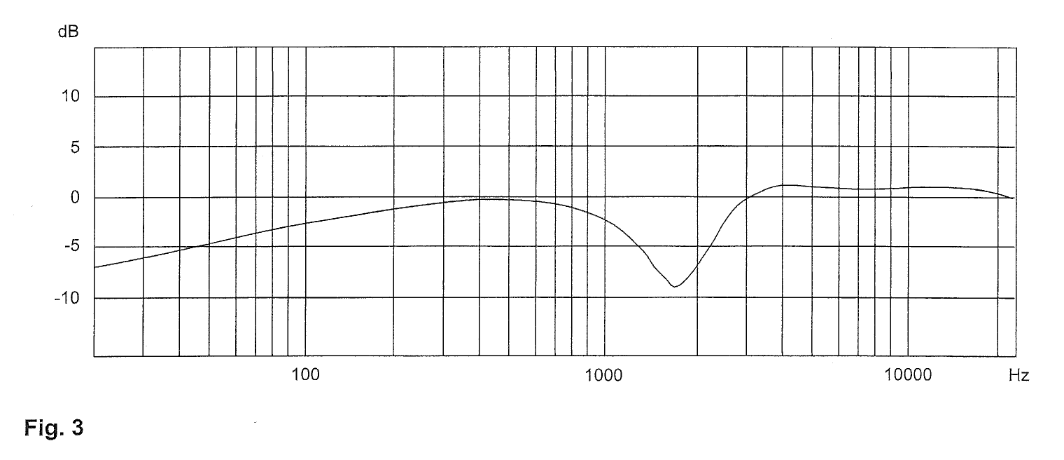

Based on the impedance characteristic, furthermore the Q-value of the combination of the electroacoustic transducer and the ear channel may be determined. Based on the resonance frequency and the Q-value the audio data to be output to the user may be adapted to improve the hearing experience of the user. For example, as shown in FIG. 3, a certain attenuation by using a filter, for example an FIR, IIR, or BiQuad filter, can be performed to adapt the audio signal to the specific combination of electroacoustic transducer and ear channel. Depending on the Q-value of the measurements the output signal will be attenuated around the center frequency of the resonance frequency for some decibels. This attenuation will thus be adapted to the particular characteristics of the user's ear. FIG. 3 shows an exemplary filtering curve for such an adaption. In this case a gain of −8 dB at 1800 Hz has been applied. However, more elaborative filtering schemes may be applied. For example, based on a software having a look up table, an equalization correction may be performed. For example, for a certain combination of resonance frequency and Q-value a certain filtering around the “critical frequency” will be managed. The amount of frequency dampening in order to find the optimum frequency response (as near flat as possible) will be chosen after subjective experimenting comprising users with different ear channel volumes. The result could be a filtering curve like that shown in FIG. 3.

This may result in a more balanced frequency response from in-ear monitors and the possibility to compensate differences in user's ear channel volumes, for example between a left and a right ear of the user.

While exemplary embodiments have been described above, various modifications may be implemented in other embodiments. For example, based on the frequency characteristic, the resonance frequency and the quality value it may be detected, if the electroacoustic transducer is correctly mounted in the ear or if it is “leaking”.

Furthermore, an abnormal change in an ear channel of the user may be determined based on the impedance characteristic, for example when the user's resonance frequency will change abruptly. An incorrect mounted electroacoustic transducer or the detected abnormal change may be notified to the user via the audio playback device.

Finally, it is to be understood that all the embodiments described above are considered to be comprised by the present invention as it is defined by the appended claims.

1. A method for determining an impedance of an electroacoustic transducer to be arranged in an ear channel of an ear of a user, the method comprising the steps of:
supplying an output signal to the electroacoustic transducer,
determining an input signal indicating an impedance of the electroacoustic transducer in response to the supplied output signal,
generating a filtered output signal by filtering the output signal, the filtered output signal mainly comprising only frequency components having a frequency within a predetermined frequency range,
generating a filtered input signal by filtering the input signal, the filtered input signal mainly comprising only frequency components having a frequency within the predetermined frequency range, and
determining the impedance of the electroacoustic transducer at the predetermined frequency range based on the filtered output signal and the filtered input signal.

2. The method according to claim 1, wherein the output signal comprises at least one audio signal of a group consisting of a speech audio signal and a music audio signal.

3. The method according to claim 1, wherein the output signal is arbitrarily selectable by the user.

4. The method according to claim 1, wherein the output signal comprises an audio signal comprising frequency components inside and outside the predetermined frequency range.

5. The method according to claim 1, wherein the predetermined frequency range comprises one or more octaves.

6. The method according to claim 1, wherein the predetermined frequency range comprises at least one frequency range of a group consisting of a first frequency range from 400 Hz to 500 Hz, a second frequency range from 500 Hz to 625 Hz, a third frequency range from 625 Hz to 800 Hz, a fourth frequency range from 800 Hz to 1000 Hz, a sixth frequency range from 1000 Hz to 1250 Hz, a seventh frequency range from 1250 Hz to 1600 Hz, an eighth frequency range from 1600 Hz to 2000 Hz, a ninth frequency range from 2000 Hz to 2500 Hz, a tenth frequency range from 2500 Hz to 3200 Hz, an eleventh frequency range from 3200 Hz to 4000 Hz, and a twelfth frequency range from 4000 Hz to 4800 Hz.

7. The method according to claim 1, wherein the step of determining the impedance of the electroacoustic transducer at the predetermined frequency range comprises determining a quotient of the filtered output signal and the filtered input signal.

8. The method according to claim 1, wherein the step of determining the input signal comprises determining a voltage over a resistor and determining the input signal based on the determined voltage, the resistor being coupled in series to the electroacoustic transducer.

9. The method according to claim 1, wherein the impedance comprises a magnitude component and phase component.

10. The method according to claim 1, wherein the electroacoustic transducer comprises an electroacoustic transducer of a portable hands free set of a mobile device.

11. The method according to claim 1, wherein the impedance of the electroacoustic transducer is determined while the electroacoustic transducer is arranged in the ear channel of the user.

12. A method for determining an impedance characteristic of an electroacoustic transducer to be arranged in an ear channel of an ear of a user, the method comprising the steps of:
determining a plurality of impedances at a plurality of different predetermined frequency ranges by performing, for each predetermined frequency range of the plurality of different predetermined frequency ranges:
supplying an output signal to the electroacoustic transducer,
determining an input signal indicating an impedance of the electroacoustic transducer based on the supplied output signal,
generating a filtered output signal by filtering the output signal, the filtered output signal mainly comprising only frequency components having a frequency within a predetermined frequency range,
generating a filtered input signal by filtering the input signal, the filtered input signal mainly comprising only frequency components having a frequency within the predetermined frequency range, and
determining the impedance of the electroacoustic transducer at the predetermined frequency range based on the filtered output signal and the filtered input signal, and
determining the impedance characteristic based on the plurality of different predetermined frequency ranges and the correspondingly determined plurality of impedances.

13. A method for operating an audio playback device, the audio playback device comprising an electroacoustic transducer to be arranged in an ear channel of an ear of a user of the audio playback device, the method comprising the steps of:
determining a resonance frequency of the electroacoustic transducer, and
adapting an audio output signal output from the audio playback device via the electroacoustic transducer based on the determined resonance frequency.

14. The method according to claim 13, wherein the step of determining the resonance frequency of the electroacoustic transducer comprises:
determining an impedance characteristic of the electroacoustic transducer, determining the impedance characteristic including:
determining a plurality of impedances at a plurality of different predetermined frequency ranges by performing, for each predetermined frequency range of the plurality of different predetermined frequency ranges:
supplying an output signal to the electroacoustic transducer,
determining an input signal indicating an impedance of the electroacoustic transducer based on the supplied output signal,
generating a filtered output signal by filtering the output signal, the filtered output signal mainly comprising only frequency components having a frequency within a predetermined frequency range,
generating a filtered input signal by filtering the input signal, the filtered input signal mainly comprising only frequency components having a frequency within the predetermined frequency range, and
determining the impedance of the electroacoustic transducer at the predetermined frequency range based on the filtered output signal and the filtered input signal, and
determining the impedance characteristic based on the plurality of different predetermined frequency ranges and the correspondingly determined plurality of impedances,
searching for a maximum of a magnitude component of the impedance in the impedance characteristic, and
determining the resonance frequency based on a frequency at the maximum of the magnitude component.

15. The method according to claim 14, wherein the step of determining the resonance frequency of the electroacoustic transducer comprises:
searching for a sign change of a phase component of the impedance in the impedance characteristic, and
determining the resonance frequency based on a frequency at the sign change of the phase component.

16. The method according to claim 13, wherein the step of determining the resonance frequency is performed repeatedly in predetermined time intervals.

17. The method according to claim 13, wherein the step of determining the resonance frequency is performed in response to a user command.

18. The method according to claim 13, wherein the step of determining the resonance frequency of the electroacoustic transducer is performed while the electroacoustic transducer is arranged in the ear channel of an ear of the user.

19. The method according to claim 18, the method further comprising the steps of:
determining an impedance characteristic (21, 22) of the electroacoustic transducer, determining the impedance characteristic including:
determining a plurality of impedances at a plurality of different predetermined frequency ranges by performing, for each predetermined frequency range of the plurality of different predetermined frequency ranges:
supplying an output signal to the electroacoustic transducer,
determining an input signal indicating an impedance of the electroacoustic transducer based on the supplied output signal,
generating a filtered output signal by filtering the output signal, the filtered output signal mainly comprising only frequency components having a frequency within a predetermined frequency range,
generating a filtered input signal by filtering the input signal, the filtered input signal mainly comprising only frequency components having a frequency within the predetermined frequency range, and
determining the impedance of the electroacoustic transducer at the predetermined frequency range based on the filtered output signal and the filtered input signal, and
determining the impedance characteristic based on the plurality of different predetermined frequency ranges and the correspondingly determined plurality of impedances,
determining if the electroacoustic transducer is mounted correctly in the ear of the user based on the determined impedance characteristic.

20. The method according to claim 19, the method further comprising the steps of:
determining if a change in the ear channel has occurred based on the determined impedance characteristic.

21. The method according to claim 13, wherein the step of adapting the audio output signal comprises filtering the audio output signal by attenuating the audio output signal in a predetermined frequency range around the resonance frequency.

22. The method according to claim 13, further comprising:
determining an impedance characteristic of the electroacoustic transducer determining the impedance characteristic including:
determining a plurality of impedances at a plurality of different predetermined frequency ranges by performing, for each predetermined frequency range of the plurality of different predetermined frequency ranges:
supplying an output signal to the electroacoustic transducer,
determining an input signal indicating an impedance of the electroacoustic transducer based on the supplied output signal,
generating a filtered output signal by filtering the output signal, the filtered output signal mainly comprising only frequency components having a frequency within a predetermined frequency range,
generating a filtered input signal by filtering the input signal, the filtered input signal mainly comprising only frequency components having a frequency within the predetermined frequency range, and
determining the impedance of the electroacoustic transducer at the predetermined frequency range based on the filtered output signal and the filtered input signal, and
determining the impedance characteristic based on the plurality of different predetermined frequency ranges and the correspondingly determined plurality of impedances,
determining a quality value based on the impedance characteristic, wherein the step of adapting the audio output signal comprises filtering the audio output signal based on the resonance frequency and the quality value.

23. An audio playback device comprising:
an electroacoustic transducer to be arranged in an ear channel of an ear of a user of the audio playback device, and
a control unit coupled to the electroacoustic transducer, wherein the control unit is adapted to
supply an output signal to the electroacoustic transducer, determine an input signal indicating an impedance of the electroacoustic transducer in response to the supplied output signal,
generate a filtered output signal by filtering the output signal, the filtered output signal mainly comprising only frequency components having a frequency within a predetermined frequency range,
generate a filtered input signal by filtering the input signal, the filtered input signal mainly comprising only frequency components having a frequency within the predetermined frequency range, and
determine the impedance of the electroacoustic transducer at the predetermined frequency range based on the filtered output signal and the filtered input signal.

24. The audio playback device according to claim 23, wherein the audio playback device is adapted to:
supply an output signal to the electroacoustic transducer,
determine an input signal indicating an impedance of the electroacoustic transducer based on the supplied output signal,
generate a filtered output signal by filtering the output signal, the filtered output signal mainly comprising only frequency components having a frequency within a predetermined frequency range,
generate a filtered input signal by filtering the input signal, the filtered input signal mainly comprising only frequency components having a frequency within the predetermined frequency range, and
determine the impedance of the electroacoustic transducer at the predetermined frequency range based on the filtered output signal and the filtered input signal.

25. The audio playback device according to claim 23, wherein the audio playback device comprises at least one of a group consisting of a mobile phone, a personal digital assistant, a mobile music player, and a navigation system.

26. The audio playback device according to any one of the claim 23, wherein the audio playback device is adapted to determine the impedance of the electroacoustic transducer while the electroacoustic transducer is arranged in the ear channel of the user.
